(19) United States
(12) Patent Application Publication
(10) Pub. No.: US 2018/0290146 A1
(43) Pub. Date: Oct. 11, 2018

(54) IMPACT CRUSHER HAMMER

(71) Applicant: ZHEJIANG PACIFIC MACHINERY CO., LTD, DEQING (CN)

(72) Inventor: Zhijian ZHOU, DEQING (CN)

(73) Assignee: ZHEJIANG PACIFIC MACHINERY CO., LTD, DEQING (CN)

(21) Appl. No.: 15/606,455

(22) Filed: May 26, 2017

(30) Foreign Application Priority Data
Apr. 7, 2017 (CN) 201710224002.2
Apr. 7, 2017 (CN) 201720359158.7

(51) Int. Cl. B02C 13/28

(52) U.S. Cl. CPC B02C 13/28; B02C 2210/02

(57) ABSTRACT

An impact crusher hammer comprises a hammer shaft sleeve sleeved and mounted on a roll shaft of the impact crusher using a shaft hole. A cubic hammer body is connected above the hammer shaft sleeve through a journal. Both the front working surface and the top working surface of the hammer body are provided with two kinds of different sized elliptic cylindrical hard alloys that are evenly alternated. The elliptic cylindrical hard alloys are deeply embedded into and firmly welded with corresponding deep holes opened on the front working surface and the top working surface of the hammer body; a large area of hard welding rods is welded on two side surfaces of the hammer body corresponding to the front working surface and the top working surface of the hammer body.

### CROSS REFERENCE TO RELATED APPLICATIONS

The present application claims priority to Chinese Patent Application CN 201710224002.2 filed on Apr. 7, 2017 and to Chinese Patent Application CN 201720359158.7 filed on Apr. 7, 2017.

### TECHNICAL FIELD

The disclosure relates to an impact crusher hammer, belonging to the technical field of impact crushers.

### BACKGROUND

Impact crushers are widely applied in material crushing work, for example, in the iron making procedure of ores, including the work of subjecting exploited natural iron ores to crushing, grinding, beneficiation and other procedures to screen out fine particles with high iron content, which are called iron ore concentrates. When the impact crusher works, an electrical machine drives a rotor to rotate at high speed, materials are evenly fed into the crusher cavity, and the hammer rotating at high speed impacts, shears and tears the materials so that the materials are crushed. At present, single hammer is used mostly, it is convenient to replace and lowers the usage cost; however, present hammers have simple structure and low impact strength, and are easy to cause abrasion, thereby influencing working efficiency.

### SUMMARY

The disclosure aims to overcome the drawbacks in existing technologies and provide an impact crusher hammer which has simple structure, is convenient to use and mount, and can enhance impact strength, reduce abrasion and improve working efficiency

The aim of the disclosure is achieved by the following technical scheme. An impact crusher hammer includes a hammer shaft sleeve sleeved and mounted on a roll shaft of the impact crusher using a shaft hole, a cubic hammer body is connected above the hammer shaft sleeve through a journal, both the front working surface and the top working surface of the hammer body are provided with two kinds of different sized elliptic cylindrical hard alloys that are evenly alternated, the elliptic cylindrical hard alloys are deeply embedded into and firmly welded with corresponding deep holes opened on the front working surface and the top working surface of the hammer body; a large area of hard welding rods is welded on two side surfaces of the hammer body corresponding to the front working surface and the top working surface of the hammer body.

Preferably, a sharp corner β less than 90 degrees is formed between the front working surface and the top working surface of the hammer body, the lower part of the hammer body is integrally connected on the cylindrical hammer shaft sleeve having the shaft hole through a connection journal which is smaller than the hammer body, an arc structure connection surface is formed between the front part of the hammer body and the journal, and a large area of hard welding rods is welded on the arc structure connection surface.

The disclosure is an improvement to existing technologies; as the alternated alloys adopted are elliptic cylindrical hard alloys, they have relatively longer lengths and are deeply embedded into the working surface of the head part of the hammer body, thus the firmness of welding is improved, the abrasive resistance is enhanced and the service life is greatly prolonged; the impact crusher hammer has simple structure and is convenient to use and mount, and can greatly enhance impact strength, reduce abrasion and improve working efficiency.

### BRIEF DESCRIPTION OF THE DRAWINGS

FIG. 1 is a side-view structure diagram of the disclosure.

FIG. 2 is a front-view structure diagram of the disclosure.

### DESCRIPTION OF THE EMBODIMENTS

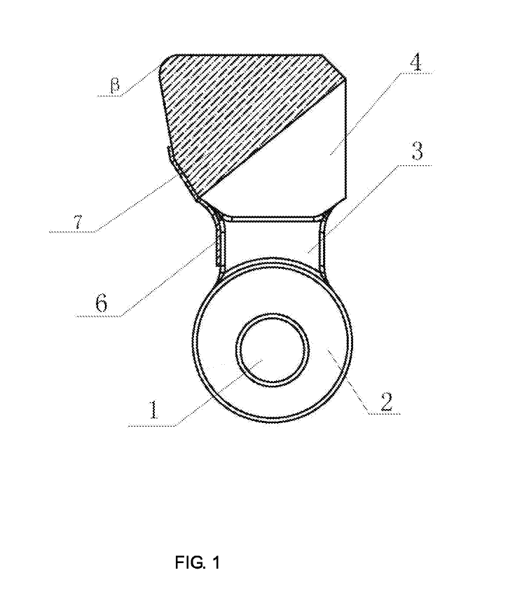

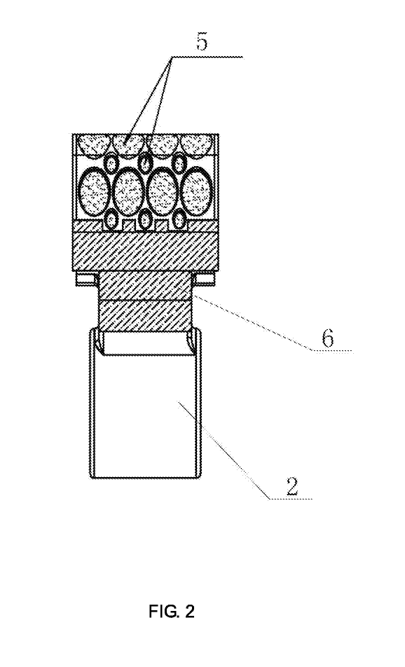

The disclosure is described below in detail in conjunction with the drawings. As shown in FIG. 1 and FIG. 2, an impact crusher hammer described in the disclosure includes a hammer shaft sleeve 2 sleeved and mounted on a roll shaft of the impact crusher using a shaft hole 1, a cubic hammer body 4 is connected above the hammer shaft sleeve 2 through a journal 3, both the front working surface and the top working surface of the hammer body 4 are provided with two kinds of different sized elliptic cylindrical hard alloys 5 that are evenly alternated, the elliptic cylindrical hard alloys 5 are deeply embedded into and firmly welded with corresponding deep holes opened on the front working surface and the top working surface of the hammer body 4; a large area of hard welding rods 7 is welded on two side surfaces of the hammer body 4 corresponding to the front working surface and the top working surface of the hammer body 4.

As shown in the drawings, a sharp corner β less than 90 degrees is formed between the front working surface and the top working surface of the hammer body 4, the lower part of the hammer body 4 is integrally connected on the cylindrical hammer shaft sleeve 2 having the shaft hole 1 through a connection journal 3 which is smaller than the hammer body 4, an arc structure connection surface is formed between the front part of the hammer body 4 and the journal 3, and a large area of hard welding rods 6 is welded on the arc structure connection surface.

The working surface of the hammer body described in the disclosure adopts two kinds of different sized elliptic cylindrical hard alloys that are distributed alternately and evenly, the elliptic cylindrical hard alloys are deeply embedded into and firmly welded with corresponding deep holes opened on the front working surface and the top working surface of the hammer body, and a large are of hard welding rods is welded on the connection place of the cubic head structured hammer body and the arc structure and on the side surface of the cubic hammer body structure respectively, so that the abrasive resistance of the product is greatly improved and the service life of the product is prolonged.

What is claimed is:

1. An impact crusher hammer, comprising a hammer shaft sleeve sleeved and mounted on a roll shaft of the impact crusher using a shaft hole, wherein a cubic hammer body is connected above the hammer shaft sleeve through a journal, both the front working surface and the top working surface of the hammer body are provided with two kinds of different sized elliptic cylindrical hard alloys that are evenly alternated, the elliptic cylindrical hard alloys are deeply embedded into and firmly welded with corresponding deep holes opened on the front working surface and the top working surface of the hammer body; a large area of hard welding rods is welded on two side surfaces of the hammer body corresponding to the front working surface and the top working surface of the hammer body.

2. The impact crusher hammer according to claim 1, wherein a sharp corner β less than 90 degrees is formed between the front working surface and the top working surface of the hammer body, the lower part of the hammer body is integrally connected on the cylindrical hammer shaft sleeve having the shaft hole through a connection journal which is smaller than the hammer body, an arc structure connection surface is formed between the front part of the hammer body and the journal, and a large area of hard welding rods is welded on the arc structure connection surface.
